(19) United States
(12) Patent Application Publication
(10) Pub. No.: US 2015/0330774 A1
(43) Pub. Date: Nov. 19, 2015

(54) OBJECT DETECTION BY WHIRLING SYSTEM

(71) Applicant: BRIGHTWAY VISION LTD., Haifa (IL)

(72) Inventors: Yoav GRAUER, Haifa (IL); David OFER, Haifa (IL); Eyal LEVI, Haifa (IL)

(73) Assignee: BRIGHTWAY VISION LTD., Haifa (IL)

(21) Appl. No.: 14/759,455

(22) PCT Filed: Jan. 6, 2014
(86) PCT No.: PCT/IL2014/050016

§ 371 Date: Jul. 7, 2015

(30) Foreign Application Priority Data
Jan. 7, 2013 (IL) 224130

(51) Int. Cl. G01B 11/22; H04N 5/04; H04N 5/33; H04N 5/232; H04N 5/225; G06T 7/00

(52) U.S. Cl. CPC G01B 11/22; H04N 5/2256; G06T 7/0051; H04N 5/33; H04N 5/23296; H04N 5/04

(57) ABSTRACT

A method for detecting objects in a scene using a synchronized illuminating and sensing process is provided herein. The method includes the following steps: illuminating a light beam along an illumination line within a scene; sensing reflections of said light, wherein said reflections come from objects located within a specified depth of field within said scene, along a sensing line; generating a tempo spatial synchronization between the illumination line and the sensing line, wherein said synchronization determines said depth of field; relatively shifting at least one of: the illuminating line, and the sensing line, based on said tempo spatial synchronization; and accumulating said reflections, thereby detecting said objects.

### BACKGROUND

1. Technical Field

The present invention relates generally to the field of spatial detection of objects using illuminating and sensing, and more particularly, to achieving same using a synchronized actuator mechanism.

2. Discussion of Related Art

Marine environments, which include lakes, seas, oceans, streams, rivers and other bodies of water, present particular challenges to vessels traveling in such environments under the various illumination conditions and various visibility conditions. For example, various types of semi submerged, or floating, obstacles and objects in marine environments, such as icebergs, whales, semi submerged metal ship containers which have fallen overboard, large underwater rocks slightly protruding from the surface of the water, wood logs and the like, pose potential threats to ship hulls and ship propellers. This potential threat is increased under low illumination and bad visibility conditions, such as at night, during a storm or in heavy rain. In addition, the detection of objects in a marine environment, such as buoys or sea marks, as well as the detection of persons who have fallen overboard, presents a challenge for individuals on vessels attempting to locate such objects and persons due to the small surface area of these objects and persons appearing above the surface of the water. As above, the task of locating small objects and persons in a marine environment is made more difficult in low illumination and bad visibility conditions. Furthermore, small objects and persons are usually undetected by radar or thermal imagers (e.g., Near Infrared, Medium Infrared or Far infrared imagers). The term ‘object’ or ‘target herein refers to semi submerged, or floating, obstacles, objects or persons in a marine environment. Objects can include icebergs, whales, semi submerged metal ship containers, large underwater rocks slightly protruding from the surface of the water at low tide, wood logs, buoys, persons and the like.

Prior art such as U.S. Pat. No. 6,693,561 to Kaplan, entitled “System for and method of wide searching for targets in a marine environment” is directed towards a system and a method of searching for targets in a marine environment and comprises a transmitter means, a processor including a receiver means, and an indicator. The transmitter means is mounted on an object, which is above water, such as on-board a marine vessel, an aircraft, or on a seaside structure. The transmitter means emits first and second beams of optical radiation at first and second zones of water. The first beam has a first wavelength characteristic having wavelengths in the ultraviolet to blue range (300-475 nanometers), and capable of entering the first zone of water and being refracted there through as a refracted beam. The second beam has a second wavelength characteristic having wavelength in the infrared range (650-1500 nanometers) and capable of reflecting from the second zone of water as a reflected beam. The processor is operative for identifying locations of the targets in the marine environment. The receiver means is operative for separately detecting return target reflections reflected off any targets impinged by the refracted and/or the reflected beams to find an identified target.

Another prior art maybe used such as U.S. Pat. No. 7,379,164 to Inbar et al., entitled “Laser gated camera imaging system and method” is directed towards a gated camera imaging system and method, utilizing a laser device for generating a beam of long duration laser pulses toward a target. A camera receives the energy of light reflexes of the pulses reflected from the target. The camera gating is synchronized to be set ‘OFF’ for at least the duration of time it takes the laser device to produce a laser pulse in its substantial entirety, including an end of the laser pulse, in addition to the time it takes the laser pulse to complete traversing a zone proximate to the system and back to the camera. The camera gating is then set ON for an ON time duration thereafter, until the laser pulse reflects back from the target and is received in the camera. The laser pulse width substantially corresponds to at least the ON time duration.

Other types of environments where object detection is required may be transportation, aerial (air to air or air to ground object detection), and terrestrial (ground to air or ground to ground object detection). In these environments the objects can a pedestrian, a vehicular or any type of desired object.

Both of these examples and radar and/or thermal based systems lack the simplicity and superior detection capabilities versus the proposed method.

### BRIEF SUMMARY

In accordance with the disclosed technique, there is thus provided a system for detecting objects under low illumination conditions, under low illumination with harsh weather conditions (e.g. rain, snow and fog) and under high illumination conditions (e.g. ambient light). The system includes a light source, a sensor, an actuator such as a whirling mechanism and a processor. The processor is coupled with the whirling mechanism (i.e. scanning), with the light source and with the sensor. The whirling mechanism provides a controlled movement of the light source and of the sensor as to each other. The moving light source generates continuous light toward the scenery. The sensor is sensitive at least to the wavelengths of the light generated by the light source. The sensor receives the light reflected from a specific volume of the scenery (depth of field) based on tempo spatial synchronization. The processor synchronizes the whirling mechanism, the light source and the sensor. The sensor is exposed to light for at least the duration of time it takes the reflected light, originating from the light source, to return from a specific volume of the illuminated scenery (depth of field).

At least a single object, within the sensor field of view and within the specific volume of the illuminated scenery (depth of field), protruding from the surface of the body of water shall reflect a light signal larger than the water reflected light signal.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic illustration of the operation of a system, constructed and operative in accordance with some embodiments of the present invention;

FIGS. 2A-2E are schematic illustrations of light propagating through space, towards, and reflecting from, an object in accordance with some embodiments of the present invention;

FIGS. 3A-3C are schematic illustrations of light propagating through space, towards, and reflecting from, objects in accordance with some embodiments of the present invention.

FIG. 4 is a schematic illustration of the operation of a system, constructed and operative in accordance with some embodiments of the present invention; and

FIGS. 5A-5C are schematic illustrations of light source output orientation versus sensor unit orientation in accordance with some embodiments of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In accordance with the present invention, the disclosed technique provides methods and systems for target or object detection, using electro-optical techniques based on the principle of sensor and active illumination synchronization. Accordingly, the terms “target” or “object” refer to any object in general, “light source” refers to any suitable source emitting of electromagnetic energy radiation (i.e. photons in any known wavelength) and “sensor” refers to any apparatus collecting of electromagnetic energy radiation (i.e. photons in any known wavelength) to provide a signal (e.g. pixel, 1D pixel array, 2D pixel array etc.). The “sensor” maybe based on; CMOS Imager Sensor, CCD, Photo-diode, Hybrid FPA, Photomultiplier (including Image Intensifier) etc.

Accordingly, the disclosed technique provides for manipulation of signal capturing in a sensor, as a function of the accumulated depth of field, by changing the light source illumination parameters, by changing the state of the sensor in a manner to the distance to the target, by changing the state of the whirling mechanism in a manner to the distance to the target, and by other factors. Transmitted or emitted light source illumination refers to a Continuous-Wave (CW) or may refer to a pulsed light source. According to one embodiment, the system is mounted on a moving platform, for example, a vehicular such as; ship, yacht, car, aircraft etc. The disclosed technique is not limited to the embodiment of a moving platform.

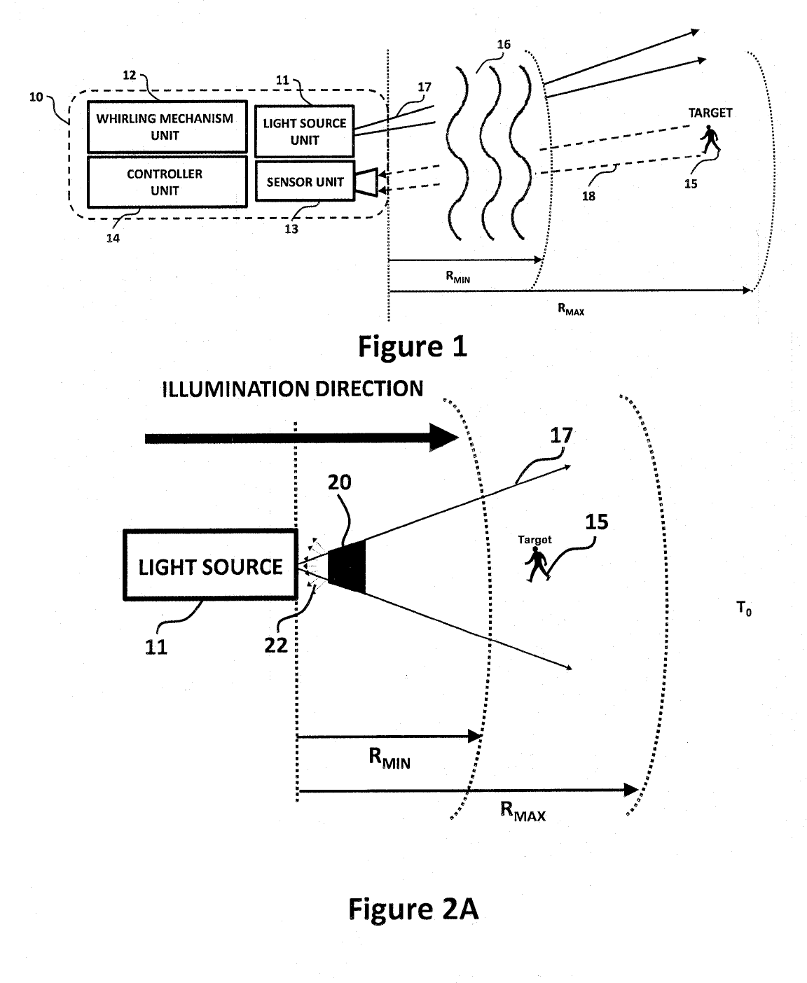

Reference is now made to FIG. 1, which is a schematic illustration of the operation of a system, generally referenced 10, constructed and operative in accordance with an embodiment of the disclosed technique.

System 10 includes a light source unit 11, a sensor unit 13, a whirling mechanism unit 12, and a controller unit (processor) 14. Light source unit 11 generates a light beam 17 in the form of CW (i.e. sinus wave to detect phase shift) or pulsed (single/series of continuous pulses). Light source unit 11 emits light beam 17 toward the scenery. Light beam 17 illuminates a potential target 15 in the scenery. Sensor unit 13 receives reflected light source beam 17 from target 15. Sensor unit 13 may have a single state; a “continuous” state during which the sensor unit 13 receives incoming light continuously. A whirling (scanning) mechanism unit 12 shifts light source unit 11 and sensor unit 13 as to each other in order to accumulate in the sensor unit 13 a specific illuminated scenery volume (depth of field) by the light source unit 11. A controller unit (processor) 14 controls and synchronizes the shifting of whirling mechanism unit 12, the light source unit 11 and the sensor unit 13 operations.

Atmospheric conditions, such as aerosols, humidity, haze, fog, smog, smoke, rain, snow and the like, represented by zone 16, exist in the surrounding area of system 10. Backscatter from the area in the immediate proximity to system 10 has a more significant influence on sensor unit 13 than backscatter from further distanced area. Approximate range designated as R_{MIN} defines the area proximate to system 10 from which the avoidance of backscattered light emitted by light source 11. The potential target 15 is not expected to be located within range R_{MIN}, therefore the removal of the influences of atmospheric conditions 16 in this range from the captured signal in the sensor unit 13. These atmospheric conditions interfere with light beam 17 on its way to illuminate target 15, and with light beam 18 reflected from target 15. For a specific scenery (subset of a three dimensional volume space), sensor unit 13 does not accumulate light beam 17 for the duration of time that light beam 17 has completely propagated a distance R_{MIN} toward target 15 in the specific scenery, including the return path to sensor unit 13 from distance R_{MIN} the specific scenery. Distance between system 10 and potential target 15 is designated range R_{MAX} (i.e. potential target 15 can be located anywhere between ranges R_{MIN} and R_{MAX} being the start point and the end points, respectively). This technique utilizes the low reflected signal background versus the high reflected signal originating from a potential target 15. In maritime environment the water is absorbing (and/or specular reflecting) most of the transmitted light signal (which is usually in the NIR).

The proposed system and technique exploits the benefits of an active illumination system and exploits the tempo spatial synchronization to avoid the backscattering. In order to clearly explain how the disclosed technique provides for the senor unit 13 accumulation manipulation of a specific volume of the scenery (depth of field , i.e. between ranges R_{MIN} and R_{MAX}), it is useful to illustrate the senor unit 13 state as to the light source unit 11 state.

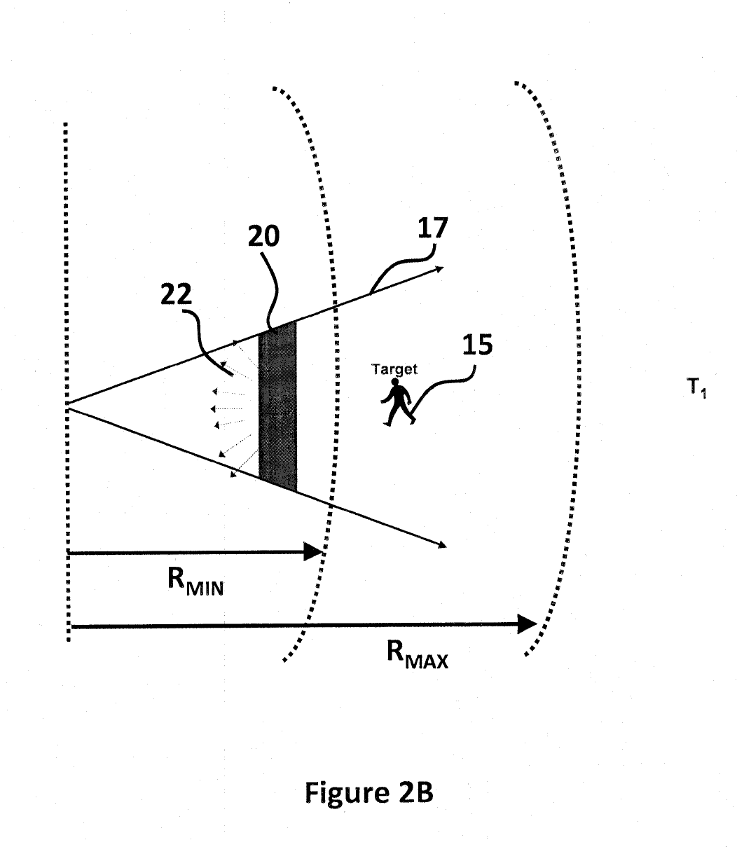

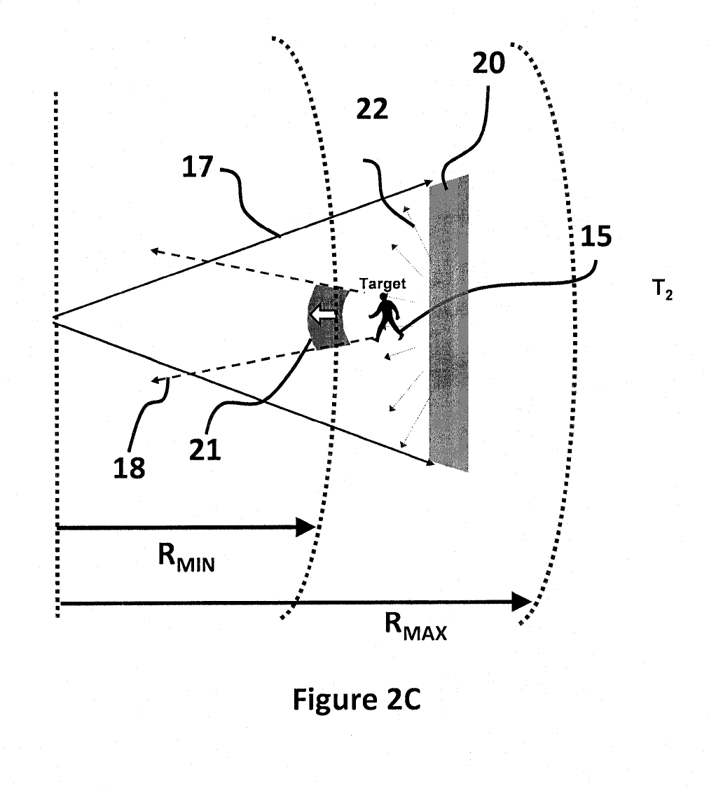

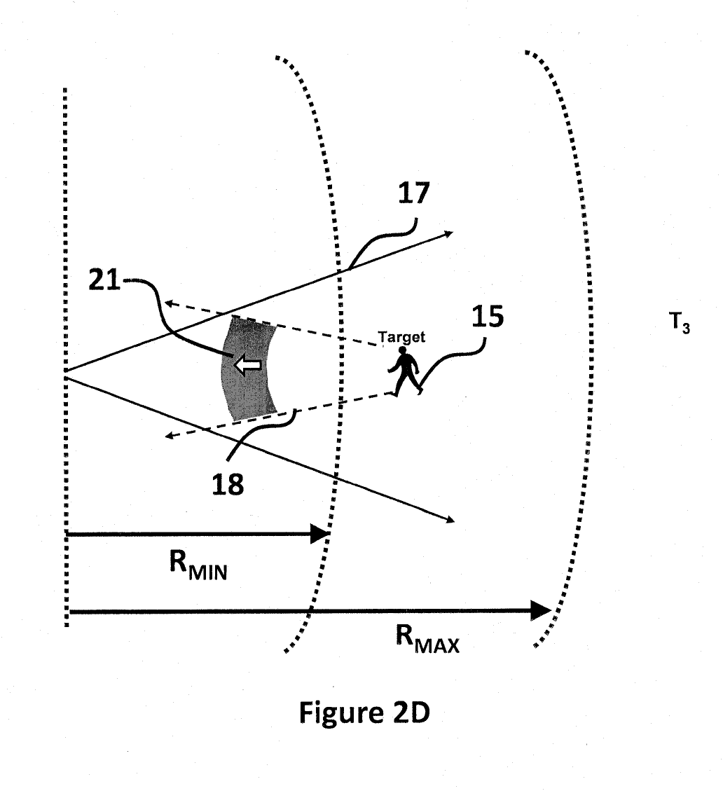

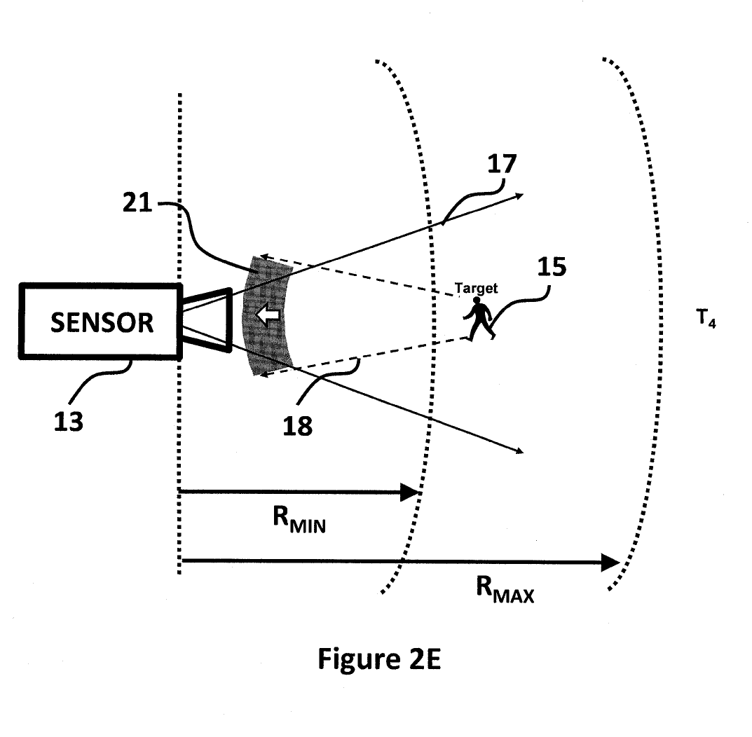

Reference is now made to FIG. 2A-FIG. 2E, which are a schematic illustrations of the operation of a system, generally referenced 10, constructed and operative in accordance with an embodiment of the disclosed technique. In order to simplify the following description single specific scenery is illustrated.

At the particular instant in time (T₀) illustrated in FIG. 2A, light source 11 emits a light beam 17 in the form of CW or pulsed (single/series of continuous pulses). Light source unit 11 emits light beam 17 toward specific scenery. Light duration 20 propagates towards the specific illuminated scenery with a potential target 15 located between ranges R_{MIN} and R_{MAX}. Light duration 20 is formed via whirling mechanism unit 12 (not illustrated). Light source reflections 22 are due to light beam 20 propagation in a medium with aerosols. During this period (starting in time T₀) sensor unit 13 is not exposed to light source reflections 22.

In time (T₁) illustrated in FIG. 2B, light source 11 (not illustrated) is not emitting light toward this specific scenery. Light duration 20 still propagates towards the specific illuminated scenery with a potential target 15 located between ranges R_{MIN} and R_{MAX}. Light source reflections 22 are due to light beam 20 propagation in a medium with aerosols. During this period (T₀ to T₁) sensor unit 13 is not exposed to light source reflections 22.

In time (T₂) illustrated in FIG. 2C, light source 11 (not illustrated) is not emitting light toward this specific scenery. Light duration 20 still propagates towards the specific illuminated scenery with a potential target 15 located between ranges R_{MIN} and R_{MAX}. Light source reflections 22 are due to light beam 20 propagation in a medium with aerosols. Light source reflection 21, within light beam 18, is reflected from a target 15 originating from light beam 20. During this period (T₁ to T₂) sensor unit 13 is not exposed to light source reflections 22 and not to target reflection 21.

In time (T₃) illustrated in FIG. 2D, light source 11 (not illustrated) is not emitting light toward this specific scenery. Light duration 20 (not illustrated) still propagates in the direction of the specific illuminated scenery (further away from R_{MAX}). Light source reflection 21, within light beam 18, is still reflected (i.e. propagating in the atmosphere). During this period (T₂ to T₃) sensor unit 13 is not exposed to light source reflections 22 (not illustrated) and not to target reflection 21.

In time (T₄) illustrated in FIG. 2E, light source 11 (not illustrated) is not emitting light toward this specific scenery. Light duration 20 (not illustrated) still propagates in the direction of the specific illuminated scenery (further away from R_{MAX}). Light source reflection 21, within light beam 18, is still reflected (i.e. propagating in the atmosphere) and now accumulated in sensor unit 13 for a specific time duration.

In order to clearly explain how the disclosed technique provides for the senor unit 13 accumulation manipulation of a specific volume (depth of field) in a 360° scenery (i.e. between ranges R_{MIN} and R_{MAX}), it is useful to illustrate the senor unit 13 state as to the light source unit 11.

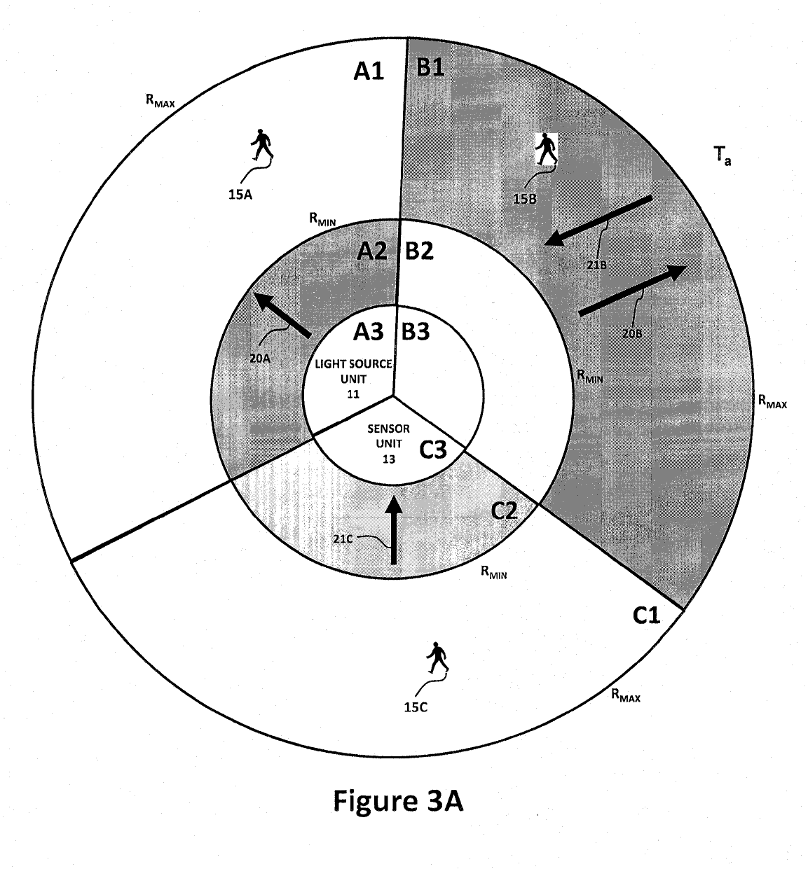

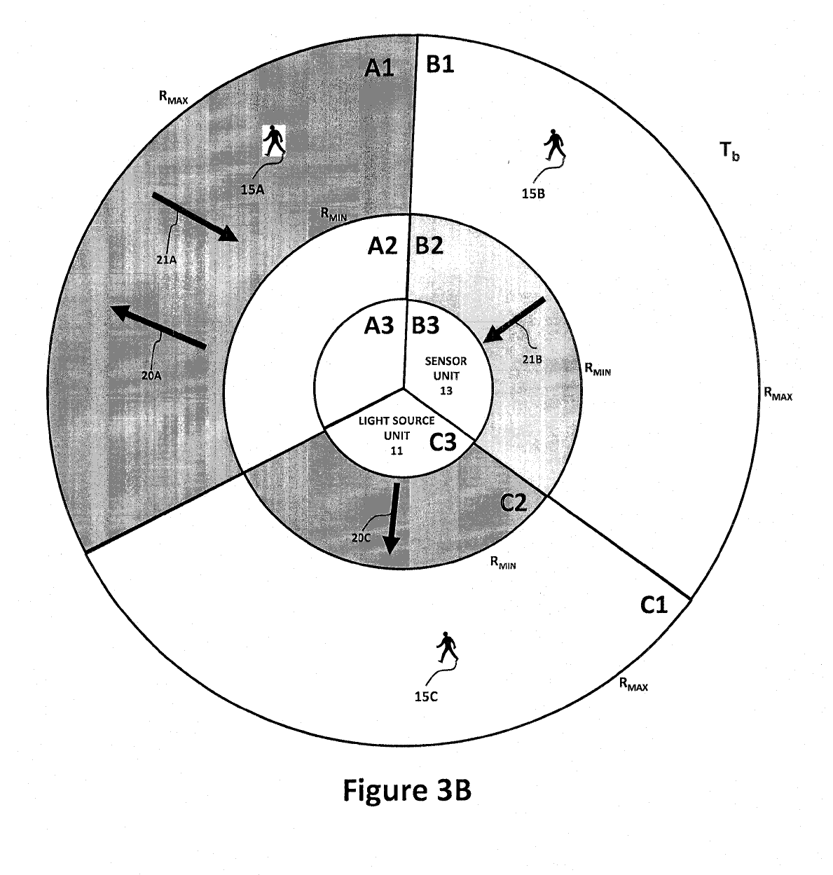

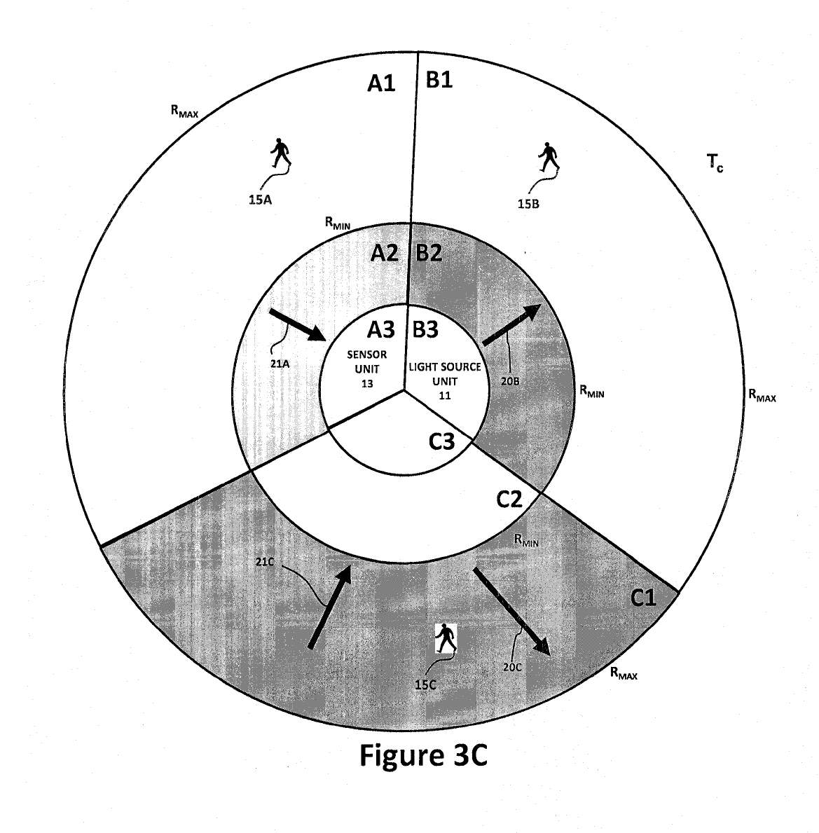

Reference is now made to FIG. 3A-FIG. 3C, which are a schematic illustrations of the operation of a system, generally referenced 10, constructed and operative in accordance with an embodiment of the disclosed technique. In order to simplify the following description three specific sceneries (i.e. zones) are illustrated as A, B and C (i.e. the proposed technique may have at least a single zone). Each specific zone is divided to three regions, for example A1, A2 and A3. Each one of the figures (FIG. 3A-FIG. 3C) represents a stationary condition of system 10 in Tₐ<T_{b}<T_{c} (time stamps). The proposed technique may have at least a single specific scenery but is not limited.

At the particular instant in time (Tₐ) illustrated in FIG. 3A, light source 11, passing through region A3, emits light with duration of 20A towards region A1. A potential target 15A is located between ranges R_{MIN} and R_{MAX} in region A1. Light duration 20A is formed via whirling mechanism unit 12 (not illustrated here. It is understood that any actuator designed for the purpose of the present invention can be used). During this period sensor unit 13, passing through region C3, accumulates only reflected light 21C origination from a reflected light signal between ranges R_{MIN} and R_{MAX} in region C1. In addition, a light with duration of 20B is reflected outwards (i.e. from B3 to B1 direction) and a reflected light signal with duration of 21B is reflected towards B3.

At the particular instant in time (T_{b}) illustrated in FIG. 3B, light source 11, passing through region C3, emits light with duration of 20C towards region C1. A potential target 15C is located between ranges R_{MIN} and R_{MAX} in region C1. Light duration 20C is formed via whirling mechanism unit 12 (not illustrated). During this period sensor unit 13, passing through region B3, accumulates only reflected light 21B origination from a reflected light signal between ranges R_{MIN} and R_{MAX} in region B1. In addition, a light with duration of 20A is reflected outwards (i.e. from A3 to A1 direction) and a reflected light signal with duration of 21A is reflected towards A3.

At the particular instant in time (T_{c}) illustrated in FIG. 3C, light source 11, passing through region B3, emits light with duration of 20B towards region B1. A potential target 15B is located between ranges R_{MIN} and R_{MAX} in region B1. Light duration 20B is formed via whirling mechanism unit 12 (not illustrated). During this period sensor unit 13, passing through region A3, accumulates only reflected light 21A origination from a reflected light signal between ranges R_{MIN} and R_{MAX} in region A1. In addition, a light with duration of 20C is reflected outwards (i.e. from C3 to C1 direction) and a reflected light signal with duration of 21C is reflected towards C3.

Whirling mechanism unit 12 shifts light source unit 11 and sensor unit 13 as to each other in order to accumulate in the sensor unit 13 a specific illuminated scenery volume (depth of field) by the light source unit 11.

System 10 timing sequence is provided by the following physical parameters illustrated in FIG. 4. For simplicity consideration a single specific scenery (zone A) is illustrated with a potential target 15 and atmospheric conditions 16. For speed of light (c, for a refractive index equal to 1) system 10 may have the following physical parameters (light source 11 field-of-illumination angle is not taken into account).

$${R}_{MIN} = R - \frac{Δ R}{2} , \qquad ( 1 )$$

where
R_{MIN}=defines the area proximate to system 10 from which the avoidance of backscattered light emitted by light source 11;
R=defines the desired distance from system 10 to an optional target 15; and
ΔR=defines the desired specific volume of the scenery (depth of field) as to an optional target 15 located in a distance of R.

$${R}_{MAX} = R + \frac{Δ R}{2} , \qquad ( 2 )$$

where
R_{MAX}=defines the distance between system 10 and potential target 15.

$${t}_{1} = \frac{2 {R}_{MIN}}{c} , \qquad ( 3 )$$

where
t₁=defines the time it takes the “first” photon to propagate from light source 11 a distance R_{MIN} and be reflected back to system 10.

$${t}_{2} = \frac{2 {R}_{MAX}}{c} , \qquad ( 4 )$$

where
t₂=defines the time it takes the “first” photon to propagate from light source 11 a distance R_{MAX} and be reflected back to system 10.

$$α = ω {t}_{1} , ω = \frac{α c}{2 {R}_{MIN}} , \qquad ( 5 )$$

where
α=defines the angular shift of light source 11 as to sensor unit 13;
ω=defines the angular velocity of whirling mechanism 12.

$$Δ t = {t}_{2} - {t}_{1} = \frac{2 Δ R}{c} ; \qquad ( 6 )$$

where
Δt=defines the accumulation time of sensor unit 13 as to a specific desired range and range volume.

$$β = ωΔ t , β = \frac{α}{( \frac{R}{Δ R} - 1 )} ; \qquad ( 7 )$$

where
β=defines the minimal angular FOV of sensor unit 13.

Angular velocity of whirling mechanism 12 (ω) may be created via a MEMS such as an optical MEMS minor rotating/flipping to provide the desired angular velocity.

Upon signal accumulation in sensor unit 13 a signal adaptive threshold maybe implemented in order to dissolve reflected target signal versus background signal. Adaptive threshold can be based at least partially on at least one of: a respective depth of field, ambient light conditions, type of objects, light source electro-optical parameters, and sensor unit electro-optical parameters.

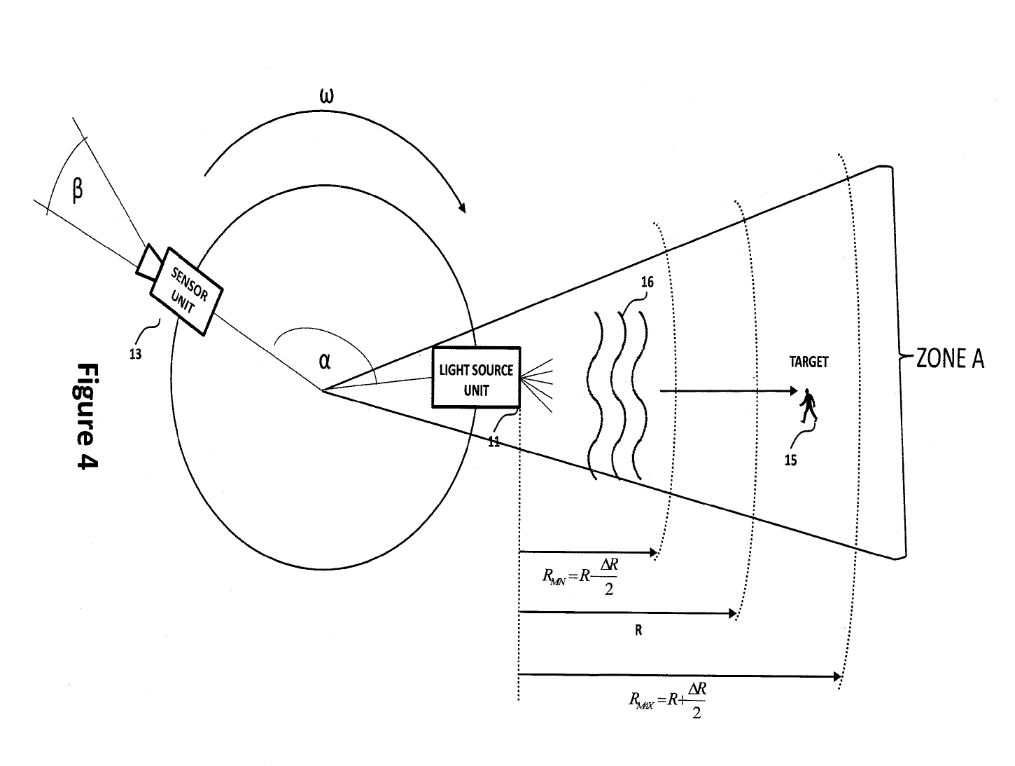

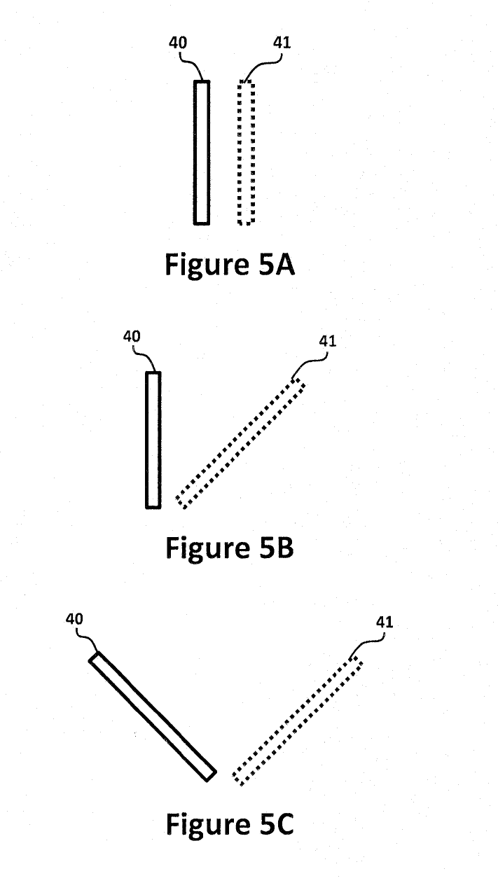

An adaptive depth-of-field can be provided by configuring light source unit 11 and sensor unit 13 shapes, dimensions and orientation versus each other as illustrated in FIG. 5A-5C (frontal view). FIG. 5A illustrates a frontal view of a parallel configuration where light source unit 11 output illumination 41 as to sensor unit 13 input 42. FIG. 5B-C illustrate a frontal view of a diagonal configurations where light source unit 11 output illumination 41 as to sensor unit 13 input 42.

Upon object detection by system 10 additional sensors can be used to validate, investigate or rule-out these potential objects automatically using an image processing algorithm or manually by the operator. Validating or ruling out potential objects may affect the system adaptive threshold in order to reduce false rate or to increase detection sensitivity. Validating or ruling out potential objects may affect the tempo spatial synchronization in order to adapt the depth-of-field accordingly (for example if a false detection is created from a known object detected by one of the additional sensors then a different depth-of-field shape is needed) Additional sensors coupled to the object detection can be: an infrared imager (e.g., a forward Looking Infrared (FLIR) imager operating in either the 3 to 5 micrometer band using an InGaAs sensor or in the 8 12 micrometer band), an ultraviolet camera, ‘passive’ sensor (e.g. CCD, CMOS), ultrasonic sensor, RADAR, LIDAR etc.

Light source unit 11 and sensor unit 13 maybe shifted separately to provide an addition flexibility of the system. The separate shift can be provided by different radial length of the units (hence, different angular velocity of whirling mechanism 12 to light source unit 11 and to sensor unit 13).

For simplicity reasons, system 10 was described aforementioned with a single light source unit 11 and single sensor unit 13. System 10 can comprise several sensor units 13 with a single light source 11 where each sensor unit 13 can accumulate a different depth of field based on at least one of the following; tempo spatial synchronization, wavelength and sensor unit electro-optical parameters. System 10 can comprise several light sources 11 and a single sensor unit 13 where the sensor unit 11 can accumulate a different depth of field based on at least one of the following; tempo spatial synchronization, wavelength and light source unit electro-optical parameters. System 10 can comprise several sensor units 13 with a several light sources 11 where each sensor unit 13 can accumulate a different depth of field and different detection capabilities. System 10 comprising of a dual light source 11 followed by a dual sensor unit 13 can even provide target dimension detection based on the accumulated signals from sensor units.

System 10 can control/change sensor unit 13 and light source 11 tempo spatial synchronization to optimize target detection (i.e. per a specific target, system 10 may accumulates several depth of fields to optimize the detection capabilities).

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising:
a light source configured to illuminate a light beam along an illumination line within a scene;
a sensor unit configured to generate a signal by sensing and accumulating reflections of said light, wherein said reflections come from objects located within a specified depth of field within said scene, along a sensing line;
a computer processor configured to calculate a tempo spatial synchronization between said illumination line and said sensing line, wherein said synchronization determines said depth of field being a volume of the scene that is being sensed, wherein the determined depth of field is based at least partially on: parameters of a platform to which the system is attached, and a spatial angle of the light source and/or the sensor unit; and
an actuator configured to spatially and relatively shift at least one of: said illuminating line , and said sensing line, based on said tempo spatial synchronization,
wherein the computer processor is further configured to receive said signal, based on said spatial shift of the illumination and the sensing line, for detecting the objects at the specified depth of field, and
wherein said accumulating has a start point (R_{MIN}) and an end point (R_{MAX}) which are determined by said tempo spatial synchronization.

2. The system according to claim 1, wherein the depth of field is adaptive.

3. The system according to claim 1, wherein the detecting of the objects is threshold based, wherein the threshold is based at least partially on at least one of: a respective depth of field, ambient light conditions, type of objects, light source electro-optical parameters, and sensor unit electro-optical parameters.

4. (canceled)

5. The system according to claim 1, wherein said actuator comprises a whirling mechanism and wherein said relative spatial shifting of said light source and sensor unit is rotational.

6. The system according to claim 1, wherein said light beam comprises a continuous wave (CW).

7. The system according to claim 1, wherein said light beam comprises at least a single pulse of light.

8. The system according to claim 1, wherein said light beam comprises Infra-Red (IR) spectrum.

9. The system according to claim 1, wherein said actuator comprises at least one Micro Electro Mechanical System (MEMS).

10. The system according to claim 1, wherein said computer processor is further configured to generate an image of the determined depth of field, based on objects detected therein.

11. The system according to claim 1, wherein the light source is laser.

12. The system according to claim 1, wherein the sensor unit is a 2D pixel array.

13. The system according to claim 12, wherein the sensor unit is complementary metal oxide substrate (CMOS).

14. The system according to claim 12, wherein the sensor unit is hybrid structure.

15. A method comprising:
illuminating a light beam along an illumination path within a scene;
generating a signal by sensing and accumulating reflections of said light, wherein said reflections come from objects located within a specified depth of field within said scene, along said illumination path;
calculating a tempo spatial synchronization between said illumination line and said sensing line, wherein said synchronization determines said depth of field being a volume of the scene that is being sensed, wherein the determined depth of field is based at least partially on: parameters of a platform to which the system is attached, and a spatial angle of the light source and/or the sensor unit;
spatially and relatively shifting at least one of: said illuminating line , and said sensing line, based on said tempo spatial synchronization; and
receiving said signal, based on said spatial shift of the illumination and the sensing line, for detecting the objects at the specified depth of field, wherein said accumulating has a start point (R_{MIN}) and an end point (R_{MAX}) which are determined by said tempo spatial synchronization.

16. The method according to claim 15, wherein said field of view is adaptive.

17. The method according to 15, wherein said detecting the objects is threshold-based and wherein the threshold is based at least partially on at least one of: a respective depth of field, ambient light conditions, type of objects, light source electro-optical parameters, and sensor unit electro-optical parameters.

18. (canceled)

19. The method according to 15, wherein said light beam comprises a continuous wave (CW).

20. The method according to 15, further comprising generating an image of the determined depth of field, based on objects detected therein.
